(19) United States
(12) Patent Application Publication
(10) Pub. No.: US 2017/0310027 A1
(43) Pub. Date: Oct. 26, 2017

(54) CONNECTION TERMINAL

(71) Applicant: SUMITOMO WIRING SYSTEMS, LTD., Yokkaichi, Mie (JP)

(72) Inventor: Hideki GOTO, Yokkaichi (JP)

(73) Assignee: SUMITOMO WIRING SYSTEMS, LTD., Yokkaichi, Mie (JP)

(21) Appl. No.: 15/529,742

(22) PCT Filed: Nov. 5, 2015
(86) PCT No.: PCT/JP2015/081169

§ 371 Date: May 25, 2017

(30) Foreign Application Priority Data
Nov. 26, 2014 (JP) 2014-239194

(51) Int. Cl. H01R 12/58

(52) U.S. Cl. CPC H01R 12/585

(57) ABSTRACT

A connection terminal that includes a terminal main body with a first end and a second end, wherein a connecting part is at the second end and is configured to be connected to another member; and a press-fit fixing part at the first end of the terminal main body and configured to be press-fittingly fixed to a through-hole of a substrate.

### BACKGROUND

This disclosure relates to a connection terminal that connects a substrate and an electrical component, and particularly to a connection terminal that is press-fitted and fixed to a through-hole of a substrate.

Conventionally, a connection terminal is used to electrically connect (i) a substrate such as a printed circuit board, a bus bar substrate or the like and (ii) an electrical component such as a connector or the like. A so-called press-fit terminal is known as such a connection terminal, which is disclosed in, for example, Japanese Published Patent Application 2004-127610. A press-fit fixing part having a spring property at one end is formed in such a press-fit terminal. By having the press-fit fixing part press-fit into and fixed to a through-hole of a substrate, it can be fixed to the substrate without any soldering.

Incidentally, as disclosed in Japanese Published Patent Application 2004-127610, a press-fit terminal is formed by press-punching a metal plate. Furthermore, in general, the press-fit fixing part is formed by punching out an arch-shaped opening part at an axial center of the terminal, and applying a spring property thereto.

However, among connection terminals, there are many extremely small terminals in which a width dimension or a plate thickness dimension is not even 1 mm. It is extremely difficult to form a press-fit fixing part in such a terminal according to the above-mentioned method, which caused an increase in manufacturing cost. Additionally, to ensure connection reliability of the press-fit fixing part, pressure contact is improved by ensuring a sufficient press-fitting area of the press-fit fixing part with respect to an inner surface of the through-hole. Thus, a force of inserting the press-fit fixing part into the through-hole unavoidably becomes large. For this reason, there was a concern that the press-fit fixing part might scrape off an inner surface of the through-hole and generate metal waste.

Therefore, previously, in Japanese Published Patent Application 2013-149578, the inventor of this application proposed a connection terminal in which there are formed (i) a longitudinal bar-shaped terminal main body and (ii) a press-fit fixing part in which a metal material separate from that of the terminal main body is rolled and press-fitted into contact with one end of the terminal main body. According to this, a component used for the terminal main body is separate from a component used fix the press-fit fixing part. Thus, the degree of freedom in manufacturing a press-fit fixing part is improved, and even when the plate thickness dimension of the terminal main body is short, a press-fit fixing part that can advantageously ensure a spring property can be advantageously formed. Because of this, the force of inserting the press-fitting part into the through-hole can be reduced, and the problem can also be alleviated in which the press-fitting part scrapes off the inner surface of the through-hole.

### SUMMARY

An exemplary aspect of the present disclosure maintains a press-fit fixing state of the press-fit fixing part of the connection terminal with respect to the through-hole for a long period of time and stably holds the connection terminal on the substrate for a long period of time, and further improves connection terminals have been under development.

An exemplary aspect of the present disclosure provides a connection terminal having a new structure that (i) can reduce force by which the pressing-fit fixing part is inserted through the through-hole and (ii) can maintain a press-fit fixing state of the press-fit fixing part with respect to the through-hole for a long period of time.

According to an exemplary aspect of the disclosure, a connection terminal includes a terminal main body with a first end and a second end, wherein a connecting part is at the second end and is configured to be connected to another member; and a press-fit fixing part at the first end of the terminal main body and configured to be press-fittingly fixed to a through-hole of a substrate, wherein: the press-fit fixing part is formed by assembling another metal material separate from that of the terminal main body to the first end of the terminal main body; the press-fit fixing part is provided with: elastic tongue pieces that are flexibly deformable, the elastic tongue pieces being arranged at a periphery of the first end of the terminal main body, extending in an axial direction of the terminal main body, and outwardly protruding in a direction perpendicular to the axial direction; and a pair of connecting fixing parts to which both ends of the elastic tongue pieces are respectively connected; at the first end of the terminal main body, a pair of concave portions is arranged at parts that are separated from each other in the axial direction; at the pair of connecting fixing parts of the press-fit fixing part, a pair of engaging parts is arranged that is formed so as to be recessed. toward the pair of concave portions and is engaged with the pair of concave portions; due to engagement of the pair of engaging parts with respect to the pair of concave portions, the pair of connecting fixing parts of the press-fit fixing part is respectively fixed to parts that are separated from each other in the axial direction at the first end of the terminal main body; and the press-fit fixing part is formed by bending a metal flat plate, as the another metal material, into a substantially cylindrical shape, and the pair of engaging parts is arranged at contact portions of circumferential direction end surfaces of the metal flat plate.

According to this exemplary aspect, the elastic tongue pieces can be arranged at the press-fit fixing part that is formed of a metal material separate from that of the terminal main body and press-fittingly fixed to the through-hole of the substrate. Thus, compared to a conventional case in which a spring property is applied by punching out an axial center of a terminal main body, a press-fit fixing part with an increase in an elastic deformation amount can be provided, the force by which the press-fit fixing part is inserted through the through-hole can be reduced, and the press-fit fixing part can be reliably pressed against the through-hole.

Furthermore, the press-fit fixing part is further provided with the pair of connecting fixing parts to which both ends of the elastic tongue pieces are respectively connected, and at one end of the terminal main body, the pair of connecting fixing parts is respectively fixed to parts that are separated from each other in an axial direction. Thus, loss of the pressing contact force due to the elastic tongue pieces extending in an axial direction because of the pressing contact reaction three against the through-hole is suppressed in advance. Also, a state in which the press-fit fixing part is fixed in pressing contact with respect to the through-holes can be advantageously maintained for a long period of time.

According to the connection terminal related to a first exemplary aspect of this disclosure, at the one end of the terminal main body, a pair of concave portions is arranged at the parts that are separated from each other in the axial direction; at the pair of connecting fixing parts of the press-fit fixing part, a pair of engaging parts is arranged that is formed so as to be recessed toward the pair of concave portions and is engaged with the pair of concave portions; and due to engagement of the pair of engaging parts with respect to the pair of concave portions, the connecting fixing parts of the press-fit fixing part are fixed to the parts that are separated from each other.

According to this exemplary aspect, by causing the pair of engaging parts that is formed so as to be recessed toward the pair of concave portions to be engaged to the pair of concave portions, the pair of connecting fixing parts is fixed to the portions that are separated from each other in an axial direction. Thus, deformation of the entire terminal main body can be suppressed by the concave portions arranged in the terminal main body in advance, and the engaging parts can be arranged at the pair of connecting fixing parts and engaged to the concave portions. Thus, the terminal main body and the press-fit fixing part can be accurately fixed.

According to the connection terminal related to the exemplary aspect of this disclosure, the press-fit fixing part is formed by bending a metal fiat plate, as the metal material, into a substantially cylindrical shape; and the pair of engaging parts is arranged at contact portions of circumferential direction end surfaces of the metal flat plate.

According to this exemplary aspect, by causing the pair of engaging parts, which is arranged at the pair of connecting fixing parts, to be engaged to the pair of concave parts of the terminal main body, the press-fit fixing parts can be reliably assembled and fixed to the terminal main body. Furthermore, by arranging the pair of engaging parts at the contact portions of the circumferential direction end surface of the metal flat plate, the press-fit fixing part can be reliably engaged to the terminal main body. Thus, compared to the case of Japanese Published Patent Application 2013-149578 in which a metal flat plate is rolled and press-fitted into contact with the terminal main body, the metal material forming the press-fit fixing part can be reduced.

According to an exemplary aspect of this disclosure, the press-fit fixing part has a cylindrical shape that covers the periphery of the one end of the terminal main body; and the elastic tongue pieces are arranged at three locations or more that are separated from each other in a circumferential direction of the press-fit fixing part,

According to this exemplary aspect, the press-fit fixing part has a cylindrical shape that covers the one end of the terminal main body, and the elastic tongue pieces are arranged at three locations or more that are separated from each other in a circumferential direction of the press-fit fixing part. Thus, the connection terminal can be stably held with respect to a load component that is applied to the connection terminal in a direction perpendicular to the axial direction, and a state in which the press-fit fixing part is fixed in pressing contact with respect to the through-hole can, advantageously, be stably supported for a long period of time. Furthermore, if the terminal main body is rectangular, it is desirable to arrange four elastic tongue pieces at an outward side of respective corners of the rectangular cross section of the terminal main body. Thus, the press-fit fixing part can be more reliably press-fit and held stably to the through-hole, and position stability of the connection terminal with respect to the substrate can also be advantageously maintained.

According to an exemplary aspect of this disclosure, at the connecting fixing part that is fixed to a tip end side of the terminal main body, a pull-out suppression protrusion is arranged which elastically deforms at the time of insertion into the through-hole and allows the connecting fixing part to be inserted through the through-hole, and then elastically recovers after insertion of the connecting fixing part through the through-hole and contacts the rear surface of the substrate, and suppresses the connecting fixing part from being pulled out of the through-hole.

According to this exemplary aspect, a pull-out suppression protrusion is arranged which elastically deforms at the time of insertion into the through-hole and allows the connecting fixing part that is fixed at the tip end side of the terminal main body to be inserted through the through-hole, and then elastically recovers after insertion of the connecting fixing part through the through-hole and contacts the rear surface of the substrate. Thus, even if a force to pull the press-fit fixing part out of the through-hole is applied to the connection terminal in a pull-out direction, positioning of the press-fit fixing part of the connection terminal can be stably held with respect to the through-hole.

According to an exemplary aspect of this disclosure, the tip end part of the connecting fixing part that is fixed to the tip end side of the terminal main body has a tapered shape.

According to this exemplary aspect, the tip end part of the connecting fixing part that is fixed to the tip end side of the terminal main body has a tapered shape. Thus, the tip end part of the press-fit fixing part becomes a guide, and an operation in which the press-fit fixing part of the connection terminal is inserted through the through-hole can be performed stably and efficiently.

According to this disclosure, the elastic tongue pieces that are arranged at the press-fit fixing part formed of a metal material separate from that of the terminal main body can be press-fittingly fixed to the through-hole of the substrate. Thus, compared to a conventional case in which a spring property is applied by punching out an axial center of a terminal main body, an elastic deformation amount can be increased, so the insertion force with respect to the through-hole can be reduced, and the elastic tongue pieces can be reliably press-fitted into contact with the through-hole. Furthermore, the press-fit fixing part is provided with the pair of connecting fixing parts to which both ends of the elastic tongue pieces are respectively connected, and at one end of the terminal main body, the connecting fixing parts are respectively fixed to the portions that are separated from each other in an axial direction. Thus, loss of the pressing contact force due to the elastic tongue pieces extending in an axial direction because of the pressing contact reaction force against the through-hole is suppressed in advance. Also, a state in which the elastic tongue pieces are fixed in pressing contact with respect to the through-hole can be advantageously maintained for a long period of time.

### BRIEF DESCRIPTION OF THE DRAWINGS

Various exemplary aspects of the disclosure will be described with reference to the drawings, wherein:

FIG. 1 is a perspective view showing a connection terminal of a first mode of this disclosure.

FIGS. 2(a)-2(c) show development views for explaining a method of manufacturing the connection terminal shown in FIG. 1. FIG. 2(a) shows a state after press punching. FIG. 2(b) shows a step of assembling a metal material, which is a separate component, onto a terminal main body. FIG. 2(c) shows a state after assembly.

FIG. 3 is an enlarged perspective cross-sectional view of main parts showing a state in which the connection terminal shown in FIG. 1 stands on a printed circuit board.

FIG. 4 is a perspective view showing another aspect of the connection terminal of the first exemplary aspect of this disclosure

FIG. 5 is a plan view showing a different aspect of the connection terminal of the first exemplary aspect of this disclosure.

### DETAILED OF EMBODIMENTS

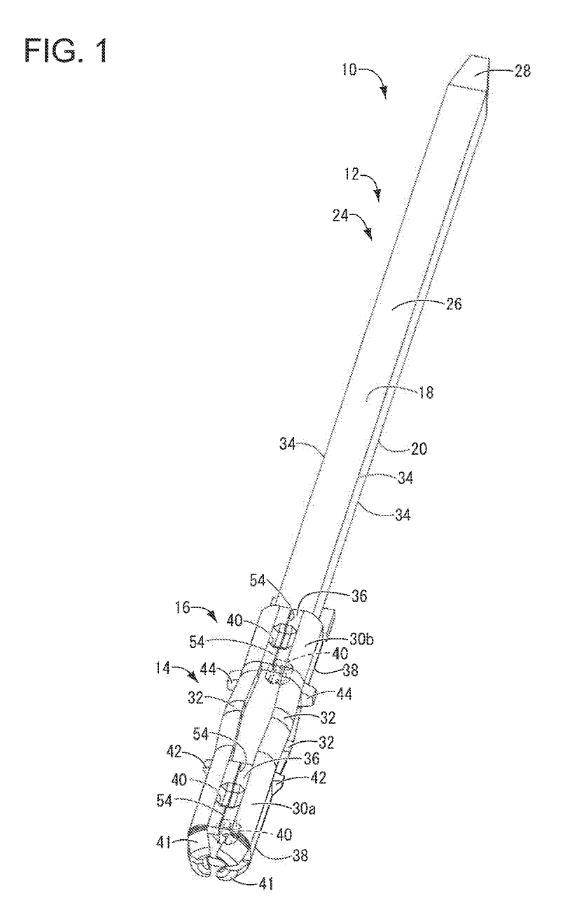

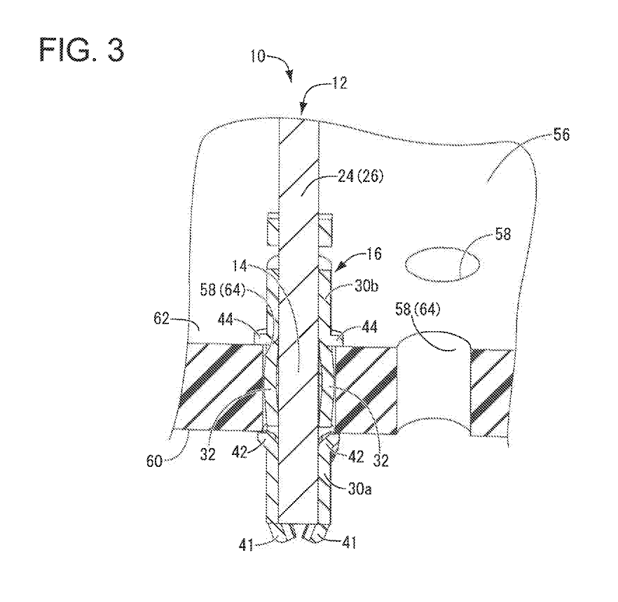

First, FIGS. 1-3 show a connection terminal 10 as a first exemplary aspect of this disclosure. In the following explanation, a longitudinal direction and up/down directions refer to up/down directions of FIG. 3, and a width direction refers to right/left directions of FIG. 3. Additionally, a plate thickness direction refers to a direction perpendicular to the paper plane of FIG. 3.

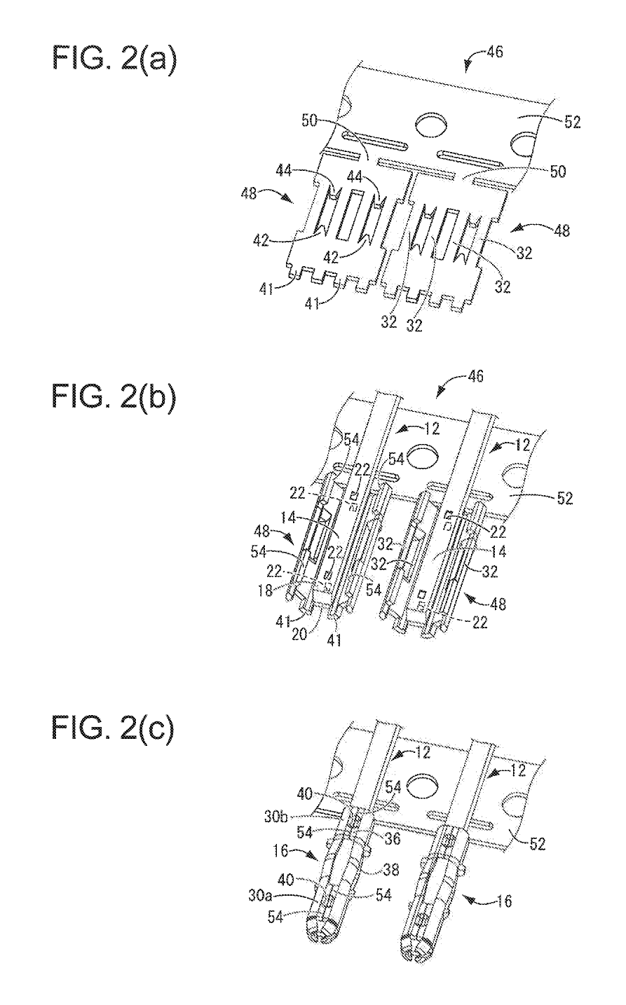

As shown in FIG. 1, the connection terminal 10 comprises (i) a terminal main body 12 and (ii) a press-fit fixing part 16, described below, that is formed by bendingly deforming a metal flat plate 48, as a metal material separate from that of the terminal main body 12, into a substantially cylindrical shape and assembling it to one end 14 of the terminal main body 12. The terminal main body 12 is, for example, a bar-shaped wire material terminal that is integrally formed by having a metal wire material cut to a specified length. The metal wire material is, for example, a wire material that is formed of copper alloy of tough pitch copper and brass or the like, or of iron or the like, and extends in a constant substantially rectangular cross-sectional shape. An entire surface of a circumference of the metal wire material is coated with a plating layer. As shown in FIG. 2(b), in a front surface 18 and a rear surface 20 of one end 14 of each of the terminal main bodies 12, a pair of concave portions 22, 22 that are substantially rectangular in a plan view and a bottom surface view is arranged at parts that are separated from each other in an axial direction. Meanwhile, as shown in FIG. 1, at the other end 24 of each terminal main body 12, a connecting part 26 is arranged that is connected to another member (undepicted) such as a mating connector terminal, and a tapered tip end part 28 is formed at the tip end part of each connecting part 26.

As shown in FIG. 1, the press-fit fixing part 16 is in a substantially cylindrical shape that covers the periphery of the one end 14 of the terminal main body 12 and is comprised of (i) a pair of connecting fixing parts 30a, 30b that are substantially cylindrical and arranged at locations at which they are separated from each other in an axial direction of the terminal main body 12, and (ii) four elastic tongue pieces 32 that are in a substantially longitudinally flat plate shape and are connected to the pair of the connecting fixing parts 30a, 30b in the axial direction. More specifically, the elastic tongue pieces 32 are arranged at four locations in which they are separated from each other in a circumferential direction of the press-fit fixing part 16 along four corners 34 of the terminal main body 12 and are formed so as to be flexibly deformable in a direction perpendicular to the axial direction by having their axial-direction center portions outwardly protrude in the direction perpendicular to the axial direction of the terminal main body 12.

Furthermore, at a front surface 36 and a rear surface 38 of the pair of connecting fixing parts 30a, 30b, at locations corresponding to the pair of concave portions 22, 22 arranged at the front surface 18 and the rear surface 20 of the one end 14 of the terminal main body 12, a pair of engaging parts 40, 40 is arranged that is recessed toward the pair of concave portions 22, 22, is engaged to the pair of concave portions 22, 22, and is substantially rectangular in a plan view and a bottom surface view. That is, parts that are separated from each other in the axial direction are formed by the pair of concave portions 22, 22. By engagement of the pair of engaging parts 40, 40 to the pair of concave portions 22, 22, the pair of connecting fixing parts 30a, 30h of the press-fit fixing part 16 is fixed to the pair of concave portions 22, 22.

In addition, at the tip end part of the connecting fixing part 30a fixed to the tip end side (lower side of FIG. 1) of the terminal main body 12, four guide pieces 41 are arranged that are in a substantially rectangular flat plate shape and extend diagonally inward of the tip end side from locations corresponding to the four corners 34 of the terminal main body 12. As a result, the tip end part of the connecting fixing part 30 has a tapered shape overall. Meanwhile, at a base end part of the connecting fixing part 30a, there is arranged a pair of pull-out suppression protrusions 42, 42, each of which has a substantially triangular cross-sectional shape, protrudes diagonally upwardly at the side, and is formed so as to be flexibly deformable in a direction perpendicular to the axial direction. Additionally, at the tip end part of the connecting fixing part 30b fixed to the base end side (upper side of FIG. 1) of the terminal main body 12, there is arranged a pair of contact protrusions 44, 44, each of which has a substantially trapezoidal cross-sectional shape and protrudes in a direction perpendicular to the axial direction of the terminal main body 12.

Next, with reference to FIG. 2, a method of manufacturing the thus-constituted connection terminal 10 is explained. First, as shown in FIG. 2(a), a fiat plate member 46 is prepared in which a metal plate to which plating of tin or the like was performed on a surface of a copper plate or the like is press-punched. In the fiat plate member 46, individual metal flat plates 48, as metal members that form the press-fit fixing parts 16, are constituted so as to be aligned in a sequence and are connected to a carrier part 52 via bridge parts 50.

Subsequently, the pairs of pull-out suppression protrusions 42, 42 of the metal flat plate 48 are bend-processed diagonally downwardly, while the pairs of contact protrusions 44, 44 of the metal flat plate 48 are bend-processed downward to a perpendicular direction. Furthermore, bend processing is performed such that the axial-direction center portion of each elastic tongue piece 32 outwardly protrudes in a direction perpendicular to the axial direction. Furthermore, as shown in FIG. 2 (b), after the terminal main bodies 12 are prepared, and one end 14 of each terminal main body 12 is placed on a width-direction center portion of the respective metal flat plate 48, the metal flat plates 48 are bent into substantially cylindrical shapes and are assembled into the respective one ends 14 of the terminal main bodies 12. More specifically, as shown in FIG. 2(c), in a state in which pairs of circumferential direction end surfaces 54, 54 of the metal flat plates 48 substantially contact each other, a caulking process is performed such that the contact locations and a position at the rear surface 38 side corresponding to each of the concave portions 22 of each of the terminal main bodies 12 are crushed so as to be recessed toward respective ones of the concave portions 22. Thus, parts of the metal flat plate 48 that constitute the pair of connecting fixing parts 30a, 30b are formed to be recessed toward the concave portions 22 of the terminal main bodies 12, and a pair of engaging parts 40, 40 is provided. As a result, at both surfaces 36, 38 of the metal flat plate 48 forming the press-fit fixing part 16, the pair of engaging parts 40, 40 is engaged to the pair of concave portions 22, 22, and the pair of connecting fixing parts 30a, 30b of the press-fit fixing part 16 is fixed to the pair of concave portions 22, 22.

As shown in FIG. 3, the thus-constituted connecting terminal 10 is inserted through a through-hole 58 of a printed circuit board 56 from the press-fit fixing part 16 side of the one end 14. A tip end part of the press-fit fixing part 16 has a tapered shape overall because of the guide pieces 41. Thus, the tip end part of the press-fit fixing part 16 becomes a guide, and an operation in which the connection terminal 10 is inserted through the through-hole 58 can be performed stably and efficiently. When the connection terminal 10 is further pushed through the through-hole 58, the pair of pull-out suppression protrusions 42, 42 arranged at the base end part of the connecting fixing part 30a of the press-fit fixing part 16 is elastically deformed inwardly, and each elastic tongue piece 32 is elastically deformed inwardly in a direction perpendicular to the axial direction. Thus, the connection terminal 10 can be inserted through the through-hole 58. Additionally, after the connection terminal 10 is inserted through the through-hole 58, the pair of pull-out suppression protrusions 42, 42 elastically recovers and contacts the rear surface 60 of the printed circuit board; thus, the connecting fixing part 30a, that is, the connection terminal 10 can be suppressed from being pulled out of the through-hole 58. Thus, even when a force to pull the press-fit fixing part 16 from the through-hole 58 in a pulling direction is applied to the connection terminal 10, positioning of the press-fit fixing part 16 of the connection terminal 10 can be stably held with respect to the through-hole 58. Furthermore, an amount of inserting the connection terminal 10 into the through-hole 58 is defined by having the pair of contact protrusions 44, 44 contact the surface 62 of the printed circuit board 56.

In such a state, as shown in FIG. 3, due to elastic recovery force based on the elastic deformation when the connection terminal 10 is inserted through the through-hole 58, the four elastic tongue pieces 32 of the press-fit fixing part 16 of the connection terminal 10 are pressed against an inner wall 64 of the through-hole 58. That is, the press-fit fixing part 16 of the connection terminal 10 is press-fittingly fixed to the through-hole 58. Thus, the connection terminal 10 is made to be conductive with undepicted internal wires of the printed circuit board 56 via (i) the four elastic tongue pieces 32 of the press-tit fixing part 16 and (ii) the plating layer arranged at the inner wall 64 of the through-hole 58.

According to the thus-constituted connection terminal 10, the elastic tongue pieces 32 are arranged at the press-fit fixing part 16, which is formed separately from the terminal main body 12, and the connection terminal 10 can be press-fittingly fixed to the through-hole 58 of the printed circuit board 56 by the elastic tongue pieces 32. Thus, compared to a conventional case in which a spring property is applied by punching out an axial center of a terminal main body, a sufficient amount of elastic deformation can be ensured. Thus, an insertion force of the connection terminal 10 into the through-hole 58 can be reduced, and the press-fit fixing part 16 can be reliably fixed in pressing contact with respect to the through-hole 58.

Additionally, both ends of the elastic tongue pieces 32 are connected to respective ones of the pair of connecting fixing parts 30a, 30b, and the pairs of connecting fixing parts 30a, 30b are respectively fixed to the pairs of concave portions 22, 22 of the respective one ends 14 of the terminal main bodies 12. Thus, loss of the pressing contact force due to the elastic tongue pieces 32 extending in an axial direction because of the pressing contact reaction force against the through-hole 58 is suppressed in advance. Also, a state in which the elastic tongue pieces 32 are fixed in pressing contact with respect to the through-holes 58 can be advantageously maintained for a long period of time. Furthermore, the concave portions 22 are arranged in the terminal main bodies 12 in advance, so deformation of the terminal main bodies 12 can be suppressed, and the pair of connecting fixing parts 30a, 30b can be engaged to the concave portions 22 by the pair of engaging parts 40, 40 that is provided by the pair of connecting fixing parts 30a, 30b that are formed to be recessed toward the concave portions 22. Thus, the terminal main body 12 and the press-fit fixing part 16 can be accurately fixed.

Furthermore, in a state in which the pair of circumferential direction end surfaces 54, 54 of the metal flat plate 48 that constitutes the press-fit fixing part 16 substantially contact each other, a caulking process is performed at positions of the contact parts corresponding to the concave portions 22 of the terminal main bodies 12. Thus, compared to the case of Japanese Published Patent Application 2013-149578 in which the metal flat plate is rolled and press-fitted into contact with the terminal main body, the size of the press-fit fixing part 16 can be reduced, and a metal material that forms the press-fit fixing part 16 can be reduced.

In addition, the elastic tongue pieces 32 are arranged at four locations in which they are separated from each other in the circumferential direction of the press-fit fixing part 16. Thus, the connection terminal 10 can be stably held with respect to a load component that is applied to the connection terminal 10 in a direction perpendicular to the axial direction, and a state can be stably supported for a long period of time in which the press-fit fixing part 16 is fixed in pressing contact with respect to the through-hole 58.

Exemplary aspects for implementing this disclosure were thus explained in detailed, but this disclosure is not limited to these specific descriptions. For example, according to other exemplary aspects, the concave portions 22 and the engaging parts 40 are substantially rectangular in a plan view and a bottom surface view, but in addition to a rhomboid shape or a polygonal shape, any arbitrary shape, such as an elliptical or round shape, can be selected. Additionally, the concave portions 22 do not need to be arranged in the terminal main bodies 12 in advance. For example, when the engaging parts 40 are formed by caulking, the concave portions 22 can also be formed at the same time. Furthermore, the parts that are separated from each other in the axial direction are not limited to the concave portions 22, and any arbitrary items can be used as long as they are engaged to the engaging parts 40. Additionally, in the above exemplary aspects, the terminal main bodies 12 are in substantially rectangular cross-sectional shape, so the four elastic tongue pieces 32 that are separated from each other in the circumferential direction of the press-fit fixing part 16 are arranged along the four corners 34 of the terminal main bodies 12. However, for example, if the terminal main body 12 is in substantially round cross-sectional shape, it is also acceptable to arrange three elastic tongue pieces 32. Furthermore, an arbitrary number of three or more elastic tongue pieces 32 can be set according to the cross-sectional shape of the terminal main body 12.

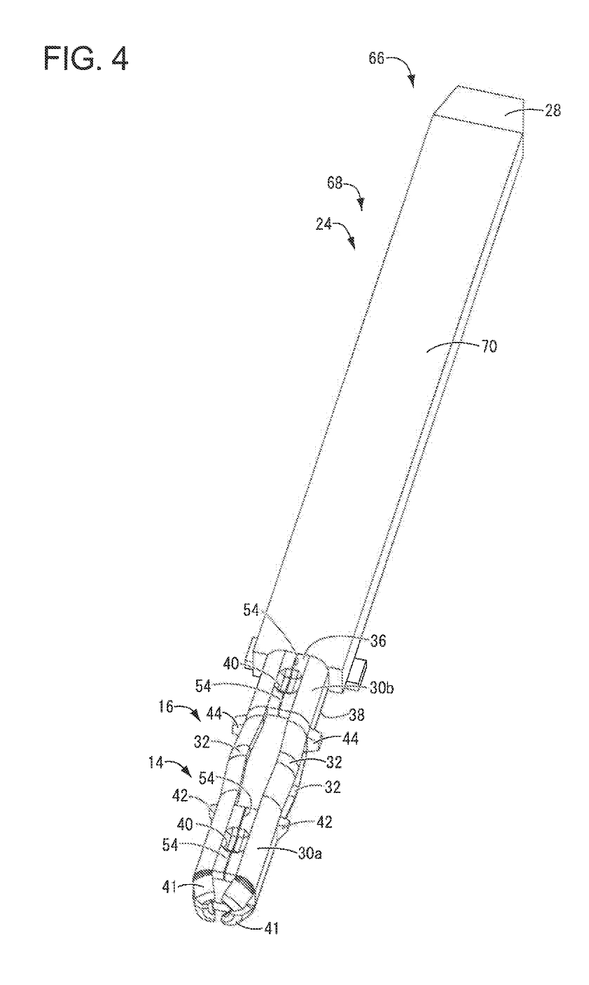

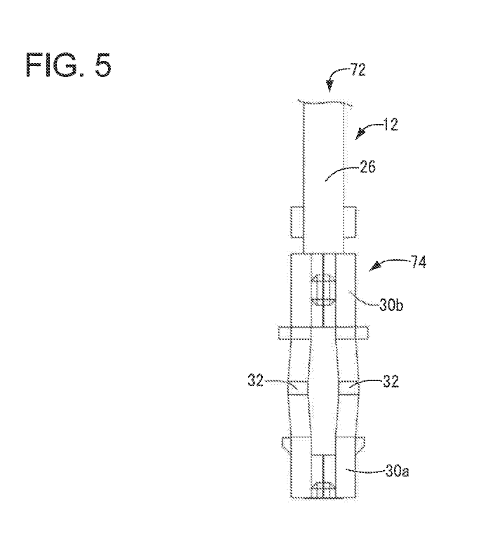

In addition, in the above exemplary aspects, the terminal main bodies 12 were bar-shaped wire material terminals. However, as in a connection terminal 66 of an exemplary aspect shown in FIG. 4, other than the above exemplary aspects, a terminal main body 68 can be formed by, for example, press-punching a metal plate in which plating of tin or the like was performed on a surface of a copper plate or the like. Thus, the shape can be varied; for example, a width of a shape of a connecting part 70 may be made large. Additionally, as in a connection terminal 72 of the exemplary aspect shown in FIG. 5, other than the above exemplary aspects, a guide piece 41 does not need to be arranged at a tip end part of a press-fit fixing part 74.

1. A connection terminal comprising:
a terminal main body with a first end and a second end, wherein a connecting part is at the second end and is configured to be connected to another member; and
a press-fit fixing part at the first end of the terminal main body and configured to be press-fittingly fixed to a through-hole of a substrate, wherein:
the press-fit fixing part is formed by assembling another metal material separate from that of the terminal main body to the first end of the terminal main body;
the press-fit fixing part is provided with:
elastic tongue pieces that are flexibly deformable, the elastic tongue pieces being arranged at a periphery of the first end of the terminal main body, extending in an axial direction of the terminal main body, and outwardly protruding in a direction perpendicular to the axial direction; and
a pair of connecting fixing parts to which both ends of the elastic tongue pieces are respectively connected;
at the first end of the terminal main body, a pair of concave portions is arranged at parts that are separated from each other in the axial direction;
at the pair of connecting fixing parts of the press-fit fixing part, a pair of engaging parts is arranged that is formed so as to be recessed toward the pair of concave portions and is engaged with the pair of concave portions;
due to engagement of the pair of engaging parts with respect to the pair of concave portions, the pair of connecting fixing parts of the press-fit fixing part is respectively fixed to parts that are separated from each other in the axial direction at the first end of the terminal main body; and
the press-fit fixing part is formed by bending a metal flat plate, as the another metal material, into a substantially cylindrical shape, and the pair of engaging parts is arranged at contact portions of circumferential direction end surfaces of the metal flat plate.

2. The connection terminal as set forth in claim 1, wherein:
the press-fit fixing part has a cylindrical shape that covers the periphery of the first end of the terminal main body; and
the elastic tongue pieces are arranged at three locations or more that are separated from each other in a circumferential direction of the press-fit fixing part.

3. The connection terminal as set forth in claim 1, wherein:
at the pair of connecting fixing parts that is fixed to a tip end side of the terminal main body, a pull-out suppression protrusion is arranged which elastically deforms at a time of insertion into the through-hole and allows the pair of connecting fixing parts to be inserted through the through-hole, and then elastically recovers after insertion of the pair of connecting fixing parts through the through-hole and contacts a rear surface of the substrate, and suppresses the pair of connecting fixing parts from being pulled out of the through-hole.

4. The connection terminal as set forth in claim 1, wherein:
a tip end part of the pair of connecting fixing parts that is fixed to a tip end side of the terminal main body has a tapered shape.

5-6. (canceled)

7. The connection terminal as set forth in claim 2, wherein:
at the pair of connecting fixing parts that is fixed to a tip end side of the terminal main body, a pull-out suppression protrusion is arranged which elastically deforms at a time of insertion into the through-hole and allows the pair of connecting fixing parts to be inserted through the through-hole, and then elastically recovers after insertion of the pair of connecting fixing parts through the through-hole and contacts a rear surface of the substrate, and suppresses the pair of connecting fixing parts from being pulled out of the through-hole.

8. The connection terminal as set forth in claim 2, wherein:
a tip end part of the pair of connecting fixing parts that is fixed to a tip end side of the terminal main body has a tapered shape.

9. The connection terminal as set forth in claim 3, wherein:
a tip end part of the pair of connecting fixing parts that is fixed to the tip end side of the terminal main body has a tapered shape.

10. The connection terminal as set forth in claim 7, wherein:
a tip end part of the pair of connecting fixing parts that is fixed to a tip end side of the terminal main body has a tapered shape.
